(19) United States
(12) Patent Application Publication
(10) Pub. No.: US 2017/0134792 A1
(43) Pub. Date: May 11, 2017

(54) Wireless Content Distribution with Synchronized Presentation

(71) Applicant: Systems and Software Enterprises, LLC, Brea, CA (US)

(72) Inventors: Eric P. Moyer, Huntington Beach, CA (US); Victor Ariño Perez, Munich (DE)

(21) Appl. No.: 15/343,937

(22) Filed: Nov. 4, 2016

Related U.S. Application Data
(60) Provisional application No. 62/252,189, filed on Nov. 6, 2015.

(51) Int. Cl. H04N 21/43; H04N 21/414; H04N 21/433; H04N 21/4363; H04N 21/488; H04N 21/84; H04N 21/214; H04N 21/472

(52) U.S. Cl. CPC H04N 21/4307; H04N 21/2146; H04N 21/41422; H04N 21/47217; H04N 21/43637; H04N 21/4882; H04N 21/84; H04N 21/4331; H04W 72/0453

(57) ABSTRACT

Systems and methods for delivering synchronized content to in-flight entertainments systems are provided. A content source having a processor, memory, and wireless communication interface can be programmed to transmit a common clock reference to a plurality of line replaceable in-flight entertainment units (LRUs). The content source can receive a command and generate a command message that includes a content identifier associated with the digital content item, a playback state of the digital content item and a presentation start time of the digital content item. The command message is transmitted to the LRUs so the LRUs each retrieves all or a part of the digital content item associated with the content identifier, and initiates playback of the retrieved digital content item at the presentation start time.

This application claims priority to U.S. Provisional Application No. 62/252,189, filed Nov. 6, 2015. This and all other extrinsic materials identified herein are incorporated by reference in their entirety to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is in-flight entertainment technologies.

### BACKGROUND

The background description includes information that may be useful in understanding the present invention. It is not an admission that any of the information provided herein is prior art or relevant to the presently claimed invention, or that any publication specifically or implicitly referenced is prior art.

As wireless technologies have continued to develop, in-flight entertainment systems have evolved to take advantage of components that communicate with each other wirelessly. These systems eliminate the need for wired connections, making the components easier to install, repair, and replace, as well as saving weight on the aircraft by eliminating the need for physical connection cables and wires. Nevertheless, in an environment such as an aircraft in flight or other vehicle in motion, bandwidth remains limited.

While in flight, it may be necessary to simultaneously play the same video content on multiple in-flight entertainment display units (e.g., integrated in seats or overhead within a passenger cabin) with a high degree of synchronization. Sending the video data from a server at the time of presentation (a.k.a. “streaming”) would require a significant amount of wireless bandwidth, which is undesirable since it would significantly reduce the amount of wireless bandwidth available to passengers for data services on their personal wireless devices. Additionally, a wireless streaming solution would be highly susceptible to service disruption caused by localized (spatial or temporal) short-term congestion, interference, or signal degradation.

Thus, there is still a need for synchronizing the presentation of wirelessly-distributed content in limited-bandwidth environments.

### SUMMARY OF THE INVENTION

The present invention provides apparatus, systems, and methods in which an in-flight entertainment system for the delivery of synchronized content is provided. Although the term “in-flight entertainment” is used, the system could readily be used in busses, boats, and other vehicles.

Preferred systems and methods include a content source comprising a processor, a memory, and a wireless communication interface. The content source can be programmed to transmit a common clock reference to a plurality of line replaceable in-flight entertainment units (LRUs), which provides an indication of a current time of a master clock to the LRUs.

A command can be received at the content source or other component to initiate playback of a digital content item across one or more of the LRUs. The content source can generate a command message, which can include a content identifier associated with the digital content item, a playback state of the digital content item and a presentation start time of the digital content item. The command message can be transmitted via the wireless communication interface of the content source, for example, to the plurality of LRUs. Each of the LRUs can receive the command message, retrieve all or a part of the digital content item associated with the content identifier, and initiate playback of the retrieved digital content item at the presentation start time.

Preferred LRUs each comprise a processor, a memory configured to store at least a portion of at least one digital content item, a wireless communication interface, and a display. LRUs can include, for example, seat-back installed units, overhead display units, or portable display units.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 provides an overview of an illustrative example of the system of the inventive subject matter.

FIG. 2 provides a flowchart of the execution of various functions and processes of the inventive subject matter.

### DETAILED DESCRIPTION

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including allowing for the wireless distribution of digital content, the synchronization of playback among multiple playback devices, and reducing network congestion in a limited-bandwidth environment.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

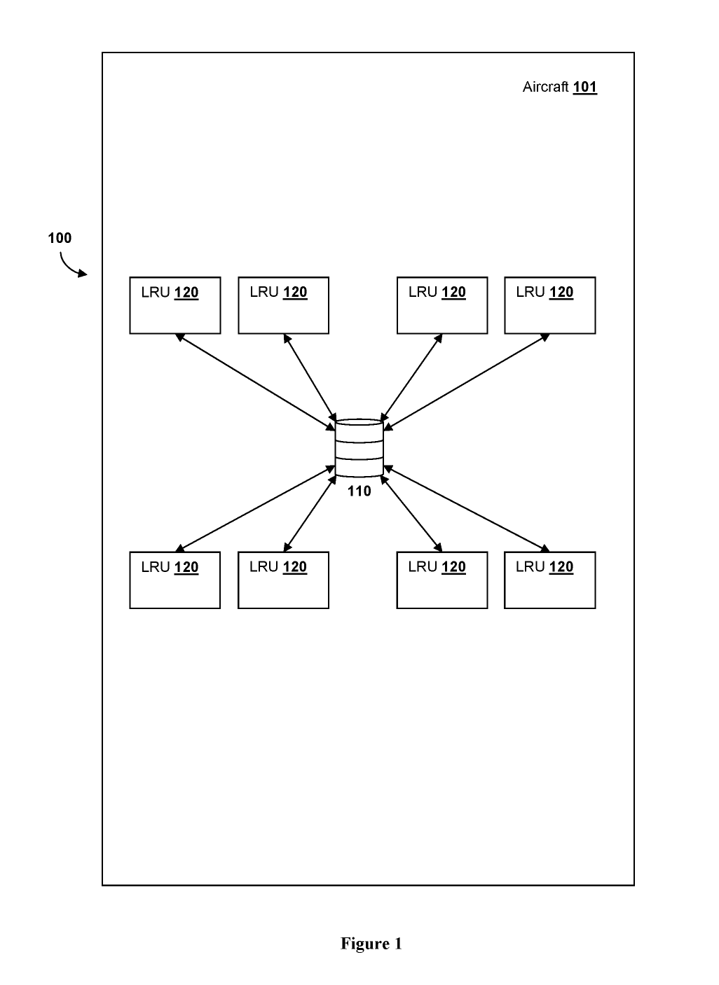

FIG. 1 illustrates an embodiment of the inventive subject matter within aircraft 101. As seen in FIG. 1, system 100 includes a content source 110 and a plurality of in-flight entertainment units 120 (also referred to herein as a “line replaceable unit” or “LRU” 120). It should be noted that the description of the inventive subject matter contained herein references an aircraft 101. However, it is contemplated that the system 100 can be applied to other vehicles such as train cars, busses, boats, or other multi-passenger vehicles or enclosed environments where wireless bandwidth is similarly limited.

Content source 110 stores digital content items (e.g., video clips, television shows, films video games, audio files) to be distributed to the LRUs 120 within an aircraft for playback. In embodiments such as the example illustrated in FIG. 1, content source 110 can be one or more content servers within the aircraft. In these embodiments, the content source 110 can connect to an external source via a wireless or wired connection (such as when the aircraft is on the ground between flights or for routine maintenance) to receive new content items and other updates.

In other embodiments, content source 110 can also be one or more of the LRUs 120 (either individually, or several LRUs 120 collectively) with sufficient storage capacity to store all of the digital content items to be eventually distributed to the other LRUs 120 within the aircraft 101. Thus, these “master” LRUs 120 can perform the functions of the content source for content storage, distribution, and playback synchronization, as well as those of the LRU for content playback.

Contemplated digital content items can include digital video content items (having a video component and an audio component or a video component without an audio component), as well as audio-only content items.

The system 100 also includes a master clock that is used as a reference clock by all of the LRUs 120 as will be discussed in further detail below. It is contemplated that the master clock can be a clock used by other systems of the aircraft 101 (e.g., such as for radio communications, navigation functions, etc.), and made accessible by the various components of system 100 for the purposes and functions of the inventive subject matter. The master clock can be housed and executed by the content source 110 and/or by one or more of the LRUs 120s (and accessible to all other LRUs 120). The common clock reference (i.e., a reference point of the master clock used by receiving devices for synchronization) can be distributed to all of the LRUs 120 via a low-bandwidth protocol such as the Precision Time Protocol (“PTP”), ensuring that the clocks are synchronized within a small margin of variance (typically less than one millisecond), while minimizing bandwidth use.

Using a master clock to synchronize all LRUs 120 is beneficial in situations where an item of digital content is to be played back simultaneously on multiple devices, such as in situations where the LRUs 120 are shared among multiple passengers. This is especially true in situations where content items are to be played back on a schedule for all LRUs 120 rather than on-demand to each passenger or LRU. For example, where LRUs 120 are overhead in-flight entertainment units (and thus, a passenger can look at the screen of more than one LRU 120 simultaneously), it is critical that the video displayed on the LRUs 120 as well as the audio from the passenger's local LRU 120, headphones jack or from the aircraft's cabin-wide audio system remains synchronized with all of the screens to ensure a positive experience by passengers.

LRU 120 can comprise a memory, a processor, a wireless interface (e.g., Wi-Fi, cellular, etc.), and display screen for video playback. In preferred embodiments, LRU 120 can include a user interface configured to receive user input, and an audio-out interface to output audio, such as a speaker and/or a headphone jack. The user interface can include a keypad, remote control, touch screen, or other suitable user interface that allows for the user to interact with the LRU 120 to access its various functions. Contemplated LRUs 120 can include entertainment units integrated into aircraft seats, such as in the seat-backs (this includes both self-contained seatback LRUs having all of the components within the seatback unit and also modular LRU systems where the display screen is integrated into the seatback but other components such as the storage, communication interfaces and/or processor(s) are located under the seat or in a separate part of the seat), overhead display units (“ODUs”), as well as portable display units.

In the illustrative example of FIG. 1, the LRUs 120 are considered to be entertainment units integrated into the seatback. In some embodiments, the LRU 120 can also include a short-rage wireless data communication interface capable of short-range data exchanges. Examples of short-range wireless interfaces include near-field communication interfaces, Bluetooth, and IR (infra-red). In embodiments, the LRU 120 can include a wired connection interface (e.g., USB, HDMI, Thunderbolt, etc.) that can be connected to other computing devices for data exchange and/or power supply.

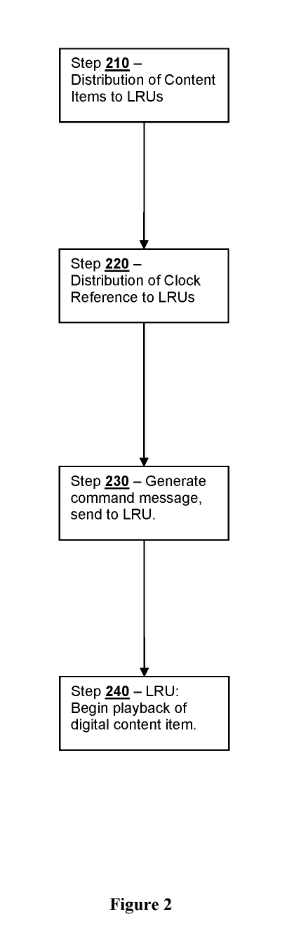

FIG. 2 outlines an illustrative example of the execution of various aspects of the inventive subject matter.

Within the environment of an aircraft in flight, the available bandwidth for wireless communications can be very limited. Thus, the digital content items are at least partially distributed in advance from the content source 110 to the LRUs 120 at step 210, such that the LRUs 120 are preloaded with the digital content items planned for presentation during a flight. To do so, the content source 110 can be programmed to push the content to the LRUs 120. Alternatively, the LRUs 120 can be programmed to request new content from the content source 110. The distribution can be prior to each flight (e.g., when the aircraft is parked at a gate between flights), during times of low-bandwidth usage during a flight, during periods when passenger wireless devices are disabled (e.g., when the aircraft is at-gate, taxiing, taking off, and landing), within a pre-set amount of time prior to a scheduled playback of a digital content item, and/or according to a periodic schedule, such as preloading of the digital content items planned for presentation on a monthly basis, bi-monthly basis, etc. It should be noted that the entirety of each digital content item does not have to be distributed at one time to every LRU 120. Rather, the distribution can occur in sections as the opportunity presents itself. For playback of the content to be able to proceed, the LRU 120 must have a minimum amount of the digital content item cached, which can be less than the complete digital content item.

At step 220, the common clock reference is distributed to the LRUs 120 from the content source 110 and/or the master LRU(s) 120 having the master clock. This step can be periodically repeated after the initial distribution to ensure that all of the LRUs 120 are maintained in synchronization.

At step 230, the content source 110 receives a command to begin playback of a digital content item and, upon receipt of the command, generates a command message. The command can be via a received user input to the content source 110 (e.g., pressing play on a user interface) other control interface accessible by the flight crew, and/or can be triggered according to a schedule for playback of the digital content item. The command message contains a content identifier (identifying the digital content item to be played back), the playback state (play, pause, idle, etc.) of the digital content and a presentation start time (relative to the shared common clock reference time of the master clock). The command message is relatively small, and low-bandwidth. The content source 110 then transmits the command message to the LRUs 120 via the wireless communication interface.

At step 240, each LRU 120 receives the command message and retrieves the digital content item corresponding to the content identifier in the command message from its memory, and begins playback of the digital content item. The initial media playback position (i.e the playback offset relative to the start of the media) is set to the current local clock time minus the presentation time (from the command message). The LRU 120 also keeps track of the elapsed presentation time since the start. If the cached amount of the digital content item stored at LRU 120 is less than a threshold, then the LRU 120 will wait until it receives enough of the digital content item to begin playback.

Subsequent to start of playback, the content source 110 can transmit periodic content messages to LRUs 120 containing the present playback state, the content identifier and the current presentation time. As the message content is very small and has a low time sensitivity, it can be sent with relatively low frequency (a few times a second or less). These messages will consume a very small percentage of available bandwidth at any given time.

As each LRU 120 receives a command message following the initial command message, it updates its local copy of the presentation start time. Each LRU 120 calculates its presentation drift (which may be positive or negative) as equal to the current media position minus the local clock time minus the presentation start time. If the presentation drift is large, it indicates that the playback of the digital content item by the LRU 120 is not in synch with the “theoretical” playback of the digital content items by the system as a whole (i.e., where the content source 110 indicates the playback “should be” in terms of time), and as such is likely out of synch with the actual playback of other LRUs 120 within aircraft 101. The LRU 120 then adjusts the playback speed of the media item (i.e., speeds up or slows down playback) such that the absolute value of the calculated presentation drift is minimized. The adjustments to the speed of the digital content item can be performed by one or more of duplicating samples/frames, dropping samples/frames, and adjusting the presentation rate.

In embodiments where one or more LRUs 120 do not have the entirety of the digital content item stored locally, the content source 110 will stream the content item to the LRUs 120 during playback such that the cached amount within the LRU 120 remains between a minimum and maximum cached amount.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An in-flight entertainment system for the delivery of synchronized content, comprising:
a content source comprising a processor, a memory, and a wireless communication interface, the content source programmed to:
transmit a common clock reference to a plurality of a line replaceable in-flight entertainment units (LRUs), the common clock reference comprising an indication of a current time of a master clock;
receive a command to initiate playback of a digital content item;
generate a command message, the command message comprising a content identifier associated with the digital content item, a playback state of the digital content item and a presentation start time of the digital content item;
transmit, via the wireless communication interface, the command message to the plurality of LRUs to cause the LRUs to initiate playback of a buffered portion of the audio component at the presentation start time; and
the plurality of LRUs, each LRU comprising a processor, a memory configured to store at least a portion of at least one digital content item, a wireless communication interface, and a display, and each LRU programmed to:
receive the command message from the content source;
retrieve the digital content item associated with the content identifier; and
initiate playback of the retrieved digital content item at the presentation start time.

2. The system of claim 1, wherein the at least a portion of at least one digital content item comprises a cached portion of the at least one digital content item.

3. The system of claim 1, wherein the content source is further programmed to transmit a content message to each of the plurality of LRUs, wherein the content message comprises a present playback state, the content identifier, and the current presentation time of the digital content item.

4. The system of claim 3, wherein each of the plurality of LRUs is further configured to:
receive the content message; and
calculate a presentation drift based on a current media position less a local clock time of the LRU less the presentation start time.

5. The system of claim 4, wherein each of the plurality of LRUs is further configured to adjust the playback of the digital content item if the presentation drift exceeds a predetermined threshold.

6. The system of claim 5, wherein adjustment of the playback of the digital content item comprises increasing or decreasing playback speed of the digital content item.

7. The system of claim 5, wherein adjustment of the playback of the digital content item comprises duplicating one or more frames of the digital content item.

8. The system of claim 5, wherein adjustment of the playback of the digital content item comprises deleting one or more frames of the digital content item.

9. The system of claim 5, wherein adjustment of the playback of the digital content item comprises adjusting the presentation rate by the LRU.

10. A method for delivery of synchronized content in an in-flight entertainment system comprising a content source and a plurality of line replaceable in-flight entertainment units (LRUs), the method comprising:
transmitting a common clock reference to a plurality of LRUs, wherein the common clock reference comprising an indication of a current time of a master clock;
receiving a command to initiate playback of a digital content item;
generating a command message at the content source, wherein the command message comprises a content identifier associated with the digital content item, a playback state of the digital content item and a presentation start time of the digital content item;
transmitting, via a wireless communication interface of the content source, the command message to the plurality of LRUs to cause the LRUs to initiate playback of a buffered portion of the audio component at the presentation start time; and
each of the LRUs
receiving the command message from the content source;
retrieving the digital content item associated with the content identifier; and
initiating playback of the retrieved digital content item at the presentation start time.

11. The method of claim 10, wherein the at least a portion of at least one digital content item comprises a cached portion of the at least one digital content item.

12. The method of claim 10, further comprising transmitting, via the content source, a content message to each of the plurality of LRUs, wherein the content message comprises a present playback state, the content identifier, and the current presentation time of the digital content item.

13. The method of claim 12, further comprising:
receiving the content message at each of the LRUs;
calculating a presentation drift at each of the LRUs based on a current media position less a local clock time of the LRU less the presentation start time.

14. The method of claim 13, further comprising each of the LRUs adjusting the playback of the digital content item if the presentation drift exceeds a predetermined threshold.

15. The method of claim 14, wherein adjustment of the playback of the digital content item comprises increasing or decreasing playback speed of the digital content item.

16. The method of claim 14, wherein adjustment of the playback of the digital content item comprises duplicating one or more frames of the digital content item.

17. The method of claim 14, wherein adjustment of the playback of the digital content item comprises deleting one or more frames of the digital content item.

18. The method of claim 14, wherein adjustment of the playback of the digital content item comprises adjusting the presentation rate by the LRU.
